(19) United States
(12) Patent Application Publication
(10) Pub. No.: US 2012/0210754 A1
(43) Pub. Date: Aug. 23, 2012

(54) SECURITY COVER FOR CARGO CONTAINERS

(76) Inventor: VERNE E. THOMSEN, Ames, NE (US)

(21) Appl. No.: 13/462,263

(22) Filed: May 2, 2012

Related U.S. Application Data
(63) Continuation-in-part of application No. 12/260,328, filed on Oct. 29, 2008.
(60) Provisional application No. 61/003,705, filed on Nov. 19, 2007.

(51) Int. Cl. E05B 65/48

(52) U.S. Cl. 70/14

(57) ABSTRACT

A security device for a shipping container of the type having doors with a vertically disposed rotatable keeper bar which is rotatable about a vertical axis and an elongated operating handle having one end pivotally secured, about a horizontal axis, to the keeper bar with the operating handle being movable between a locked position and an unlocked position with the operating handle being secured in said locked position by a hasp having a pair of legs with normally aligned holes for securing the keeper bar, the security device being adapted and arranged for securely locking said container when the keeper box is in its locked position. The security cover includes a first cover plate structure which covers the hasp and a second cover plate structure which covers the pivotal connection of the operating handle with the keeper bar. The security cover is of one-piece integral construction.

### CROSS-REFERENCE TO RELATED APPLICATION

This application is a continuation-in-part application of application Ser. No. 12/260,328, filed on Oct. 29, 2008, entitled SECURITY COVER FOR CARGO CONTAINERS, which is based on and claims priority to U.S. Provisional Application Ser. No. 61/003,705, filed on Nov. 19, 2007, which is hereby incorporated herein by reference.

### BACKGROUND OF THE INVENTION

1. Field of the Invention

The present invention is directed to locking and securement devices for trailers, trucks and train cars and, more particularly, to an improved security cover system for cargo container latches which protects not only the hasp of a shipping container latch, but also covers and protects the connection of the door handle to the door locking bar to prevent an intruder from popping the handle off of the door locking bar and then opening the door locking bar to access the contents of the shipping container.

2. Description of the Related Art

Many different types of transportation devices are used to ship goods, including shipping containers, tractor-trailers, railroad freight cars, and numerous other transportation devices. However, regardless of the type of transportation device used for the shipping of goods, securing such transport devices against unauthorized access has proven to be a most difficult task. Various devices have been proposed in the prior art, including padlock-type security devices such as those disclosed in U.S. Pat. Nos. 4,898,008 and 5,477,710 and door seal lock devices such as those disclosed in U.S. Pat. Nos. 6,009,731 and 6,036,240. However, each of these prior art devices include inherent deficiencies which permit breaches of their security and which therefore render them less than ideally suited for the task of securing a transportation device against unauthorized entry. There is therefore a need for an improved securement system for transportation devices such as cargo containers and tractor-trailers which addresses and solves these deficiencies.

One additional device disclosed in the prior art is shown in U.S. Pat. No. 6,846,024 (hereinafter “the '024 patent”), which discloses a security cover system for a cargo container latch which provides a significant improvement over many of the devices found in the prior art, yet which does not fully solve the problems encountered when determined persons attempt to gain unauthorized entry to the cargo container. Specifically, as shown in the '024 patent, particularly FIGS. 2-5 thereof, a security cover 50 is positioned over a portion of hasp 42 and the central portion of the handle 44. A locking pin is then inserted therethrough to secure the hasp in closed position and the cover 50 partially protects the hasp from unauthorized entry. However, as seen in FIG. 3 of the '024 patent, the upper pivot pin of the hasp 42 is not covered by the cover 50. Further, the cover 50 does not protect the pivotal connection of the handle 44 to the keeper bar 46, and therefore a person attempting to enter the cargo container may simply pop the pivot pin connecting the inner end of the door handle 44 to the door locking bar 46 and then rotate the keeper bar 46 once the handle 44 has been disconnected therefrom.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

An important object of this invention is to address the shortcomings of the prior art discussed above. In particular, the invention is useful in connection with shipping containers of the type having one or more doors, a rotatable keeper bar, an operating handle for rotating the bar, and a hasp securing the bar in its locked position. The principal object of the invention is to provide a security cover of the type disclosed in the co-pending application, Ser. No. 12/260,328, filed Oct. 29, 2008, entitled SECURITY COVER FOR CARGO CONTAINERS, and which completely covers the hasp and which covers the entire handle extending from the hasp to the keeper bar with the pivotal connection of the locking handle and keeper bar being covered and shielded. As will be described hereinafter, a locking block is associated with the cover so as to not only provide a means for inserting a seal pin through registering openings but which also protects the upper end of the seal pin and further protects the upper portion of the hasp.

In particular, the security cover or device comprises a first horizontally disposed and generally channel-shaped housing having: (1) an upstanding front wall with a first end, a second end, an upper end, a lower end, an inner side and an outer side; (2) an upper wall with a first end, a second end, an upper side, a lower side, an inner end and an outer end with the upper wall extending transversely inwardly from the upper end of the front wall; and (3) a lower wall with a first end, a second end, an upper side, a lower end, an inner end and an outer end with the lower wall extending transversely inwardly from the lower end of the front wall. The first end of the front wall of the first housing has a vertically-disposed plate-like extension extending laterally outwardly therefrom. A box-like member extends downwardly from the lower wall of the first housing adjacent the second end thereof with the box-like member having a vertically disposed seal pin opening formed therein. The lower end of the first housing has a first pin opening formed therein which communicates with the bore of the box-like member. The upper wall of the first housing has a second pin opening formed therein which is positioned above and in vertical alignment with the first pin opening.

The security cover also includes a vertically disposed and generally channel-shaped upstanding second housing which extends upwardly from the upper wall of the first housing adjacent the second end thereof and which includes: (1) a first upstanding side wall extending upwardly from the upper wall of the first housing and which has a lower end, an upper end, an inner end and an outer end; (2) a second upstanding side wall which extends upwardly from the upper wall of the first housing which is spaced from the first side wall thereof with the second side wall having a lower end, an upper end, an inner end and an outer end; (3) an upstanding outer wall extending from the upper wall of the first housing between the outer ends of the first and second side walls thereof with the outer wall having an upper end and a lower end; (4) the first side wall, the second side wall and the outer side wall of the second housing defining a locking block chamber having an open upper end; (5) the inner wall of the second housing having a locking device opening formed therein; and (6) a locking device positioned in the locking device opening.

The second pin opening in the upper wall of the first housing is positioned between the first side wall, the second side wall and the outer wall of the second housing. The cover also includes an elongated seal pin having upper and lower ends with a locking block mounted on the upper end thereof. The seal pin is adapted to be extended downwardly through the first and second pin openings. The locking block is received in the locking block chamber when the seal pin is extended downwardly through the second and first seal pin openings. The locking block has an opening formed therein which is adapted to receive a locking pin from the locking device positioned in the locking device opening to lock the seal pin in its downwardly extended position in the second and first pin openings.

Preferably, the first and second housings of one-piece cast construction.

The security cover of this invention completely covers the hasp assembly and that portion of the locking handle which extends from the hasp assembly to the pivotal connection with the keeper bar with that pivotal connection being completely enclosed.

### BRIEF DESCRIPTION OF THE DRAWINGS

FIG. 1 is an exploded front perspective view of the security cover of this invention;

FIG. 2 is an exploded rear perspective view of the security cover of this invention;

FIG. 3 is a rear elevational view of the security cover of this invention;

FIG. 4 is a perspective view of the security cover and a portion of the cargo door to which it is attached;

FIG. 5 is a perspective view similar to FIG. 4 except it illustrates the security cover in its locked position on the cargo door;

FIG. 6 is a top elevational view of the hasp assembly and locking handle;

FIG. 7 is a partial sectional view similar to FIG. 6 except that the security cover of this invention is shown in its locked position;

FIG. 8 is a partial rear sectional view which illustrates the security cover in its locked position; and

FIG. 9 is a perspective view similar to FIG. 4 except that a different style hasp assembly is illustrated.

### DETAILED DESCRIPTION OF THE PREFERRED EMBODIMENTS

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The security cover of this invention is designated by the reference numeral 10. For purposes of description, cover 10 will be described as having an upper end 12, a lower end 14, a first end 16, a second end 18, an inner side 20 and an outer side 22.

Cover 10 is generally comprised of a vertically disposed cover section 24 and a horizontally disposed cover section 26 which extends transversely with respect to cover section 24 below the upper end thereof. The upper portion of cover section 24 is generally channel-shaped and includes a first side wall 28, a second side wall 30, and an outer wall 32 extending between the outer ends of walls 28 and 30. A horizontally disposed wall 34 extends between walls 28, 30 and 32 below the upper ends thereof and has a seal pin opening 36 formed therein. The upper ends of walls 28, 30 and 32 and the wall 34 define a locking block and hasp receiving chamber 38. As seen, the inner end of wall 34 is recessed at 40 which is adapted to receive the upper portion of a hasp as will be described in more detail hereinafter. Cover section 24 also includes a horizontally disposed lower wall 42 having a seal pin opening 44 formed therein which is in alignment with seal pin opening 36. The lower end of side wall 28 has an opening 46 formed therein and a notch 48 formed therein.

A box-like and solid protrusion 50 extends downwardly from lower wall 42 and has a bore 52 formed therein which is a continuation of seal pin opening 44. The inner side of wall 42 is also recessed at 54 which is adapted to receive the lower end of the hasp as will be described hereinafter.

Cover section 26 includes an upper wall 56 which extends horizontally from the wall 30 as seen in the drawings. Cover section 26 also includes an outer wall 57 which extends horizontally from the wall 30 and a lower wall 58 which extends from the lower end of wall 30. Walls 56, 57 and 58 define an operating handle receiving chamber 60. Plate 62 is secured to and extends between the inner sides of walls 56 and 58 at the end of cover section 26. The end of wall 56 has a vertically disposed protector plate 64 extending therefrom.

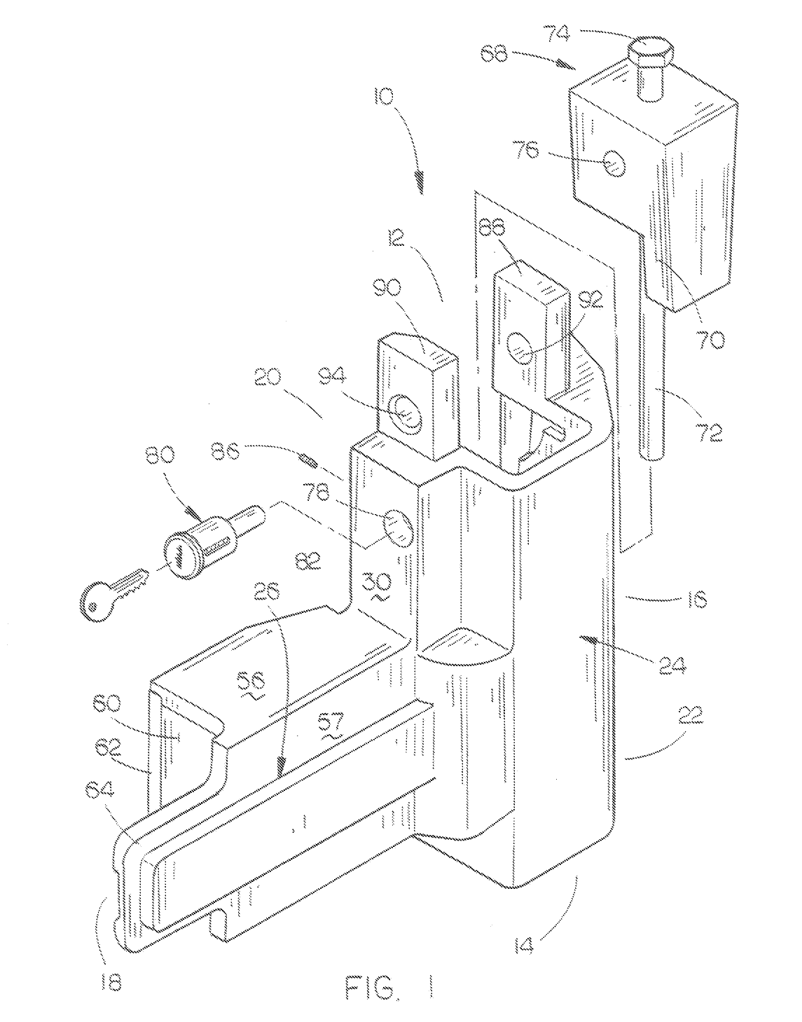

The numeral 68 refers to a locking block including a recessed spacer bar 70 extending downwardly from the lower outer end thereof. An elongated seal pin 72 extends downwardly from locking block inwardly of spacer bar 70. Preferably, a short handle 74 extends upwardly from locking block 68. Locking block 68 has a locking pin opening 76 formed in the side thereof as seen in FIG. 1.

Wall 30 of cover section 24 has a cylindrical opening 78 extending therethrough which is adapted to have a cylindrical locking device 80 mounted therein which has a locking pin 82 associated therewith which is adapted to be received in the locking pin opening 76 in locking block 68 when the locking device 80 is locked. A tapped opening 84 extends outwardly into wall 30 from the inside surface thereof which communicates with opening 78. A set screw 86 is threadably extended in tapped opening 84 and engages locking device 80 to prevent a thief from removing the locking device 80 from opening 78.

A pair of seal lugs 88 and 90 extend upwardly from the upper ends of walls 28 and 30 respectively and have seal openings 92 and 94 formed therein adapted to have a connection seal extending therebetween with the seal being extended therebetween which is above the upper end of block 68. If locking block is moved upwardly from its locked position, the seal will be broken which will indicate that cover has been possibly removed from the door.

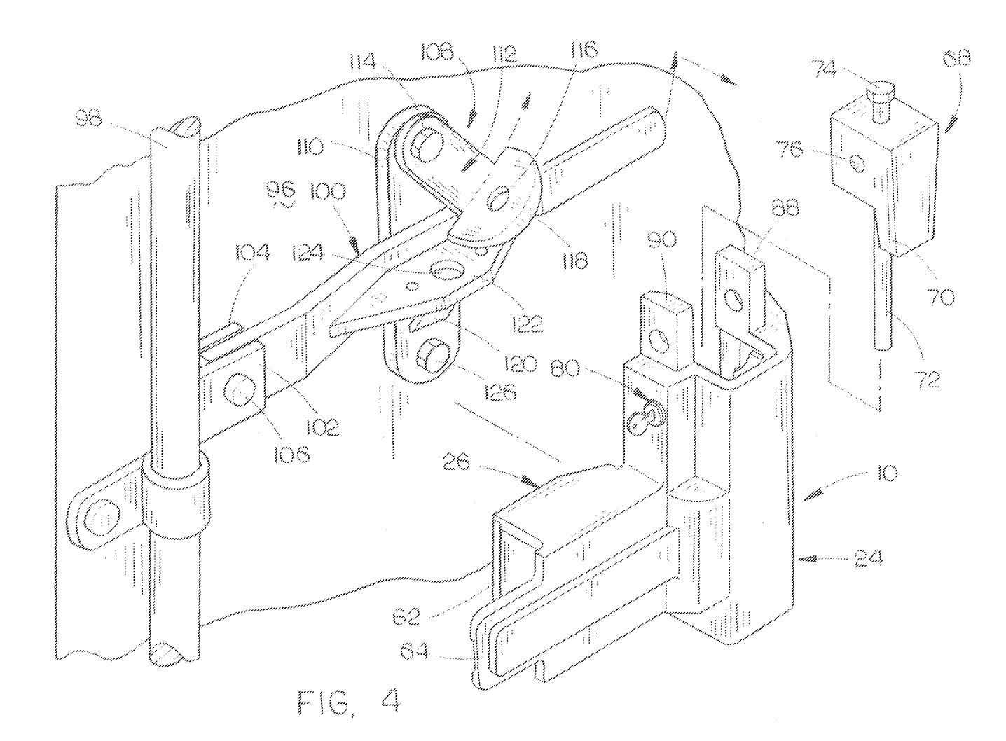

The security cover or device of this invention is designed to be used in connection with shipping containers of the type having one or more doors 96, a rotatable keeper bar 98, and an operating handle 100 which is pivotally secured to a pair of ears 102 and 104 welded to keeper bar 98 and which extend horizontally therefrom. The inner end of an operating handle 100 is received between ears 102 and 104 and is pivotally secured thereto by a pivot pin 106. A hasp assembly 108 is secured to door 96 laterally from keeper bar 98. Hasp assembly 108 includes a base plate 110 having a hasp member 112 pivotally secured thereto by pivot pin or bolt 114. The lower end of hasp member 112 has a seal pin opening 116 formed therein and a downwardly and outwardly clip portion 118. Base plate 110 has a clip 120 which extends upwardly and outwardly from base plate 110 which is adapted to receive the lower edge of handle 100 when handle 100 is in the locked position of FIG. 4. Locking handle 100 has a horizontally disposed plate 122 extending therefrom which has a seal pin opening 124 formed therein. The lower end of base plate 110 is secured to door 96 by a bolt 126.

A modified form of a conventional hasp assembly 108′ and operating handle 100′ is illustrated in FIG. 9. In FIG. 9, the operating handle 100′ does not have a shelf with a seal pin opening formed therein. In FIG. 9, the base plate 110′ does not have a clip corresponding to clip 120 but has a lower hasp member 128 which is pivotally secured to bolt 126 with the hasp member 128 having a seal pin opening formed therein which registers with seal pin opening 116′ in hasp member 112′. Handle 100′ is locked into the hasp assembly 108′ as seen in FIG. 9.

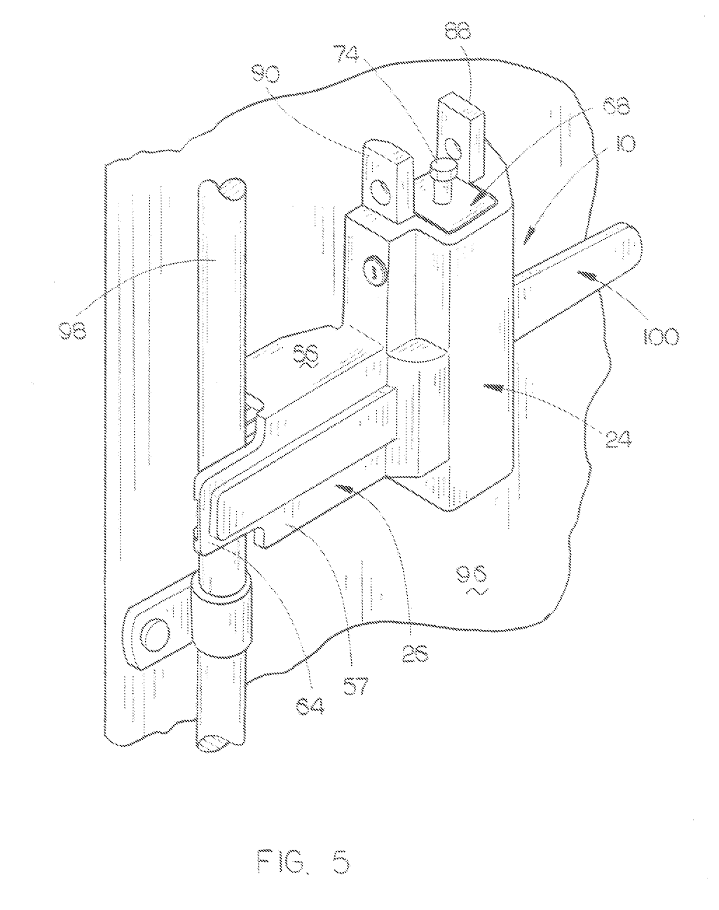

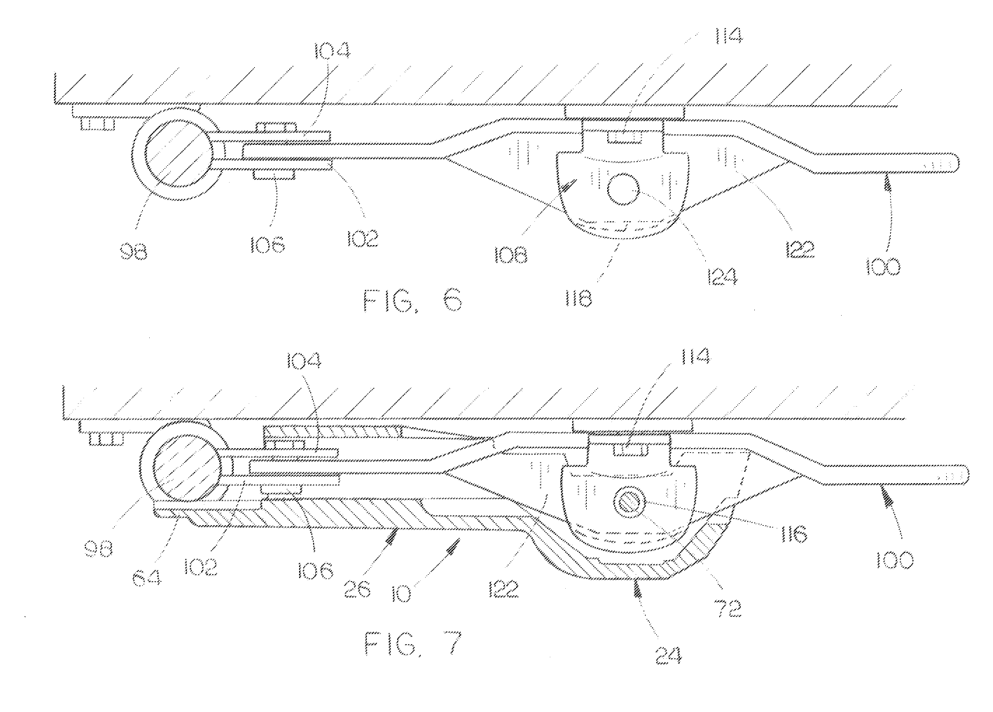

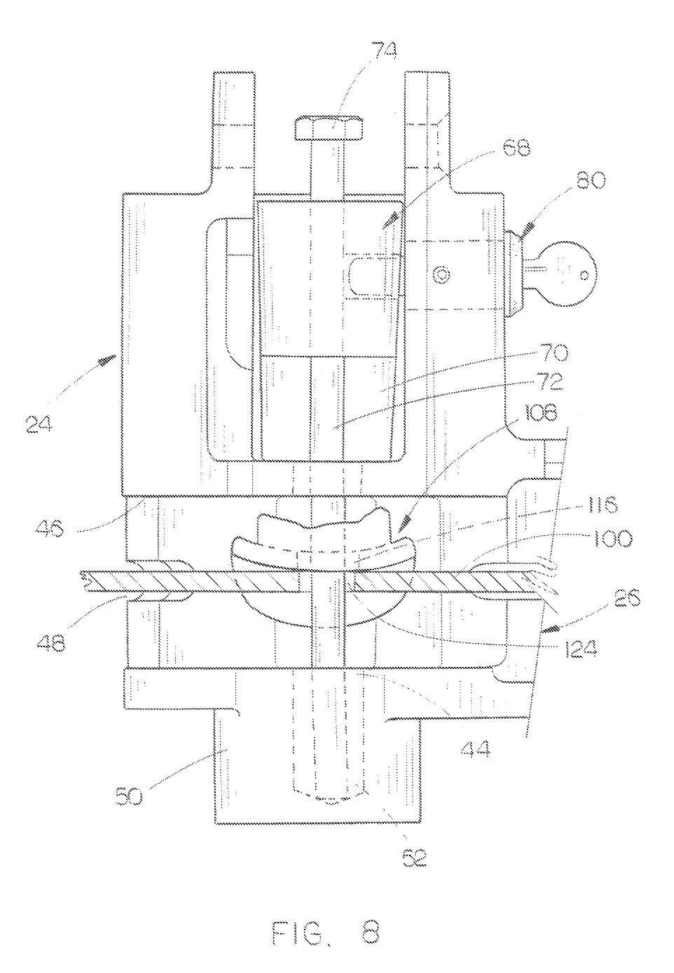

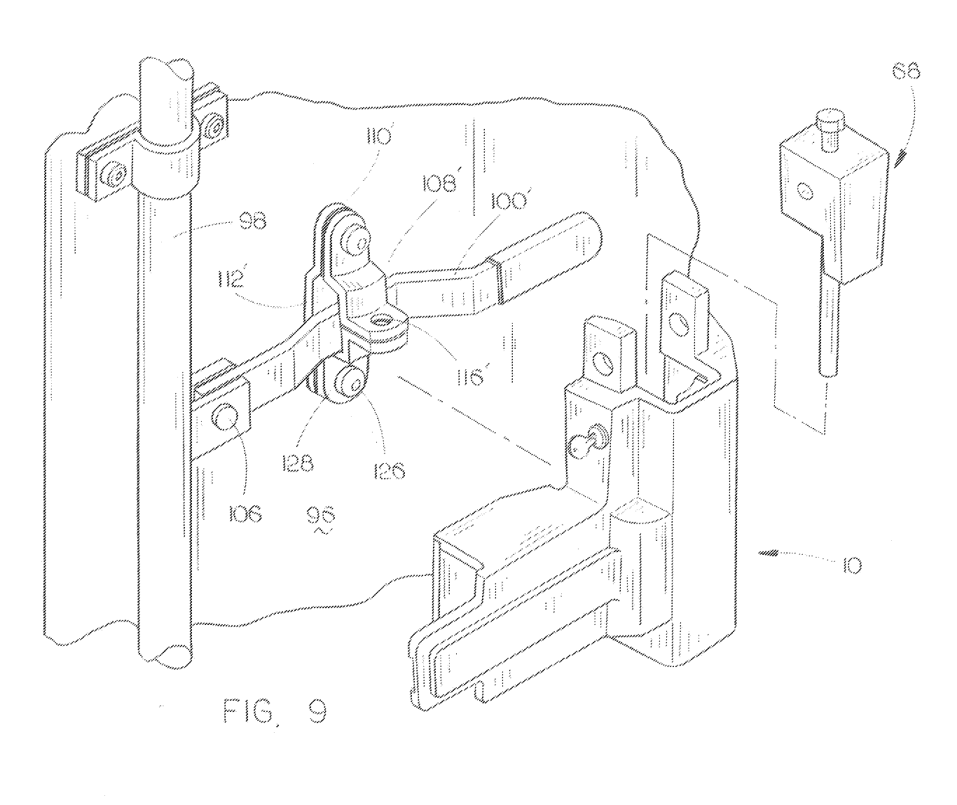

When it is desired to secure the security device 10 to the door 96 to prevent the door 96 from being opened in an unauthorized manner, the operating handle is removed from the hasp assembly 108. The security device 10 is slipped onto the free end of the operating handle 100 and slidably moved to the left as viewed in FIG. 4 so that the inner end of handle 100 is received between the walls 56, 57, 58 and plate 62. The security device 10 is moved towards the keeper bar 98 until the plate 64 overlaps a portion of the keeper bar as seen in FIG. 5. At that time, the handle 100 is positioned so as to be received in the clip 120. Hasp member 112 is then pivotally moved until the seal pin opening 116 registers with the seal pin opening 124 in shelf 122 of locking handle 100.

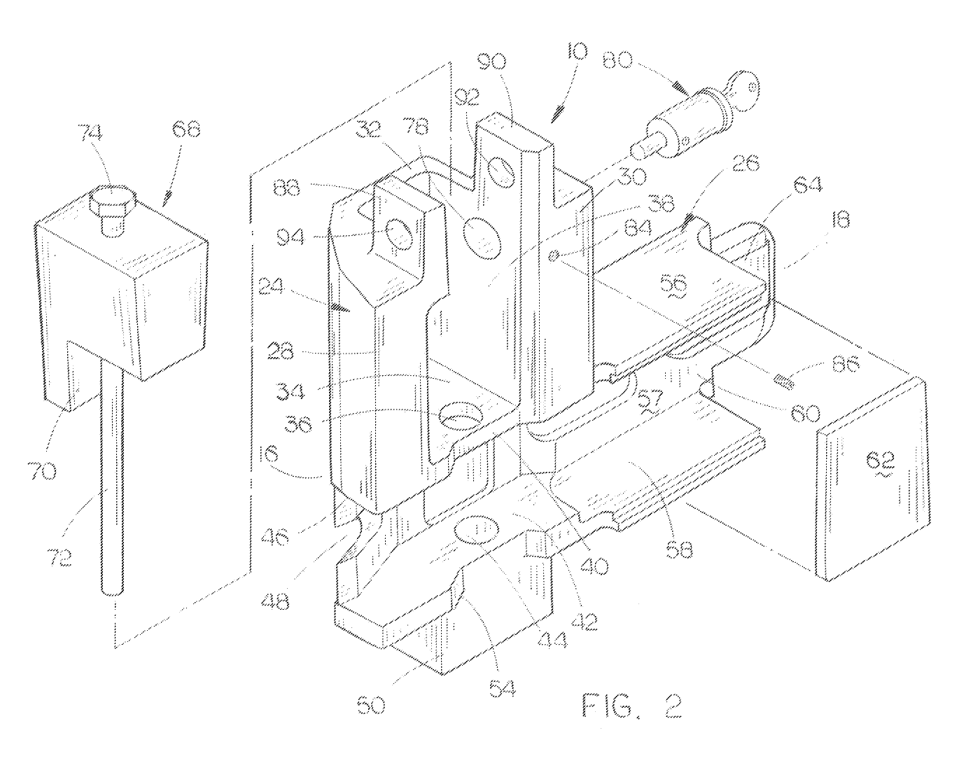

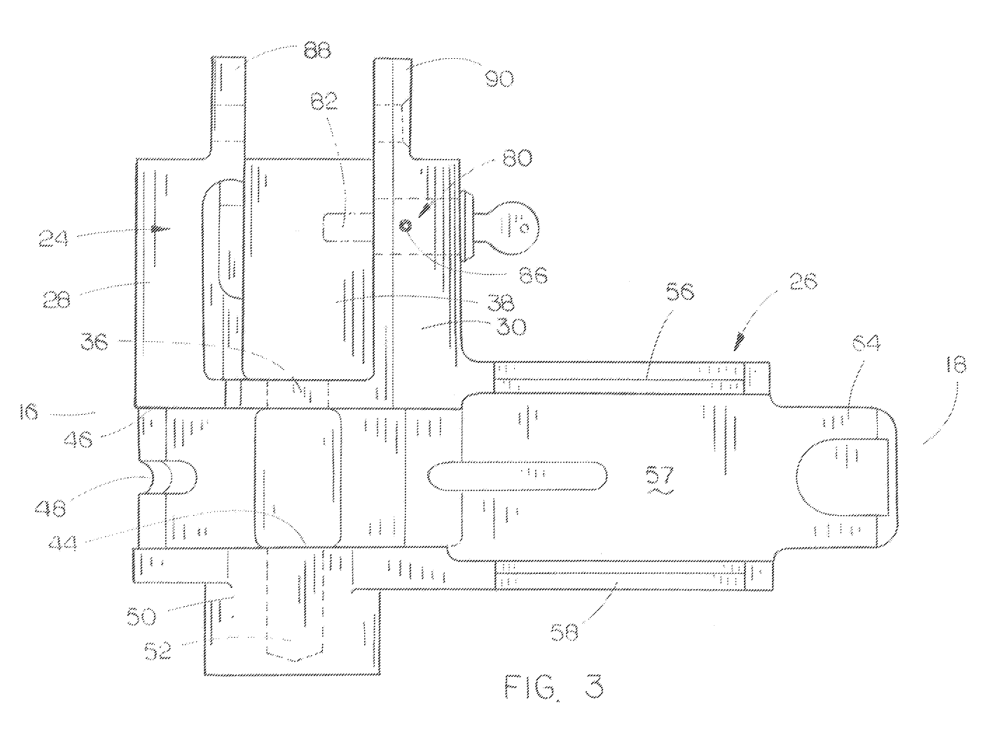

The security cover 10 is then moved inwardly towards door 96 until it is substantially flush with door 96. Locking block 68 is then inserted downwardly into chamber 38 in the manner illustrated in FIG. 2 so that seal pin 72 is extended downwardly through seal openings 36, 116, 124 and 44. Locking device 80 is then locked so that pin 82 is extended inwardly through opening 78 in wall 30 and opening 74 in locking block 68. At that time, the lower end of spacer bar 70 will be resting on wall 36. At that time, the protector plate 64 will partially embrace keeper bar 98. At the same time, the plates 102 and 104 and the pivot pin 106 will be shielded within walls 56, 57, 60 and plate 62 to prevent access to pivot pin 106 by a thief. The hasp assembly 108 and the bolts 114 and 126 thereof will be completely covered or shielded by the security cover 10 to prevent access to the critical parts of the hasp assembly 108. In other words, when the security cover is locked onto the door 96, the pivot pins 106, 114 and 126 are completely covered or shielded to prevent a thief from gaining access to the interior of the cargo compartment.

The cover of this invention works equally well with the locking handle 100′ and the hasp assembly 108′.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. A security device for a shipping container of the type having doors with inner and outer sides, a vertically disposed rotatable keeper bar at the outer side of the doors and which is rotatable about a vertical axis and an elongated operating handle having inner and outer sides with one end thereof being pivotally secured, about a horizontally disposed first pivot pin, to the keeper bar with the operating handle being movable between a locked position and an unlocked position with the operating handle being secured in said locked position by a hasp with normally aligned holes for securing the keeper bar, the security device being adapted and arranged for securely locking said container doors when the keeper bar is in said locked position, the security device comprising:
a first horizontally disposed and generally channel-shaped housing having:
(a) an upstanding front wall with a first end, a second end, an upper end, a lower end, an inner side and an outer side;
(b) an upper wall with a first end, a second end, an upper side, a lower side, an inner end and an outer end, said upper wall extending transversely inwardly from said upper end of said front wall;
(c) a lower wall with a first end, a second end, an upper side, a lower side, an inner end and an outer end, said lower wall extending transversely inwardly from said lower end of said front wall;
said first end of said front wall of said first housing having a vertically-disposed plate-like extension extending laterally outwardly therefrom;
a box-like member having an upstanding outer wall, an upstanding inner wall, an upstanding first side wall, an upstanding second side wall, and a bottom wall;
said box-like member extending downwardly from said lower wall of said first housing adjacent said second end thereof;
said lower wall of said first housing having a first pin opening formed therein which communicates with the interior of said box-like member;
said upper wall of said first housing having a second pin opening formed therein which is positioned above and in vertical alignment with said first pin opening;
a vertically disposed and generally channel-shaped upstanding second housing extending upwardly from said upper wall of said first housing adjacent said second end thereof and including:
(a) a first upstanding side wall extending upwardly from said upper wall of said first housing and having a lower end, an upper end, an inner end and an outer end;
(b) a second upstanding side wall extending upwardly from said upper wall of said first housing which is spaced from said first side wall thereof, said second side wall having a lower end, an upper end, an inner end and an outer end;
(c) an upstanding outer wall extending upwardly from said upper wall of said first housing between said outer ends of said first and second side walls thereof, said outer wall having an upper end and a lower end;
(d) said first side wall, said second side wall and said outer side wall of said second housing defining a locking block chamber having an open upper end;
(e) said inner wall of said second housing having a locking device opening formed therein;
(f) a locking device positioned in said locking device opening;
said second pin opening in said upper wall of said first housing being positioned between said first side wall, said second side wall and said outer wall of said second housing;
an elongated seal pin having upper and lower ends;
a locking block mounted on said upper end of said seal pin;
said seal pin adapted to be extended downwardly through said second and first pin openings;
said locking block being received in said locking block chamber when said seal pin is extended downwardly through said second and first seal pin openings;
said locking block having an opening formed therein adapted to receive a locking pin from said locking device positioned in said locking device opening to lock said seal pin in its downwardly extended position in said second and first pin openings;
said first and second housings being of one-piece construction;
said inner wall of said box-like member, second housing and said first housing defining a hasp receiving and shielding zone which completely shields said hasp assembly;
said first housing and said vertically disposed plate-like extension defining a locking handle receiving and shielding zone which extends from said hasp receiving and shielding zone to completely cover that part of said locking handle which extends from said hasp assembly to the pivotal connection of said locking handle and said keeper bar and which completely encloses the pivot connection of said locking handle with said keeper bar with said plate-like extension partially extending over said keeper bar.

2. The security cover of claim 1 wherein a vertically disposed plate is secured to and extends between said inner ends of said upper and lower walls of said first housing at said first end of said first housing to define a chamber which surrounds the pivotal connection of said locking handle to said keeper bar.

3. The security cover of claim 1 wherein said upper ends of side walls and said outer wall of said second housing together with said locking block completely shield said upper end of said seal pin.

4. The security device of claim 1 wherein a handle is secured to said locking block which extends upwardly therefrom.

5. The security cover of claim 1 wherein a seal support extends upwardly from the upper end of each of said side walls of said second housing.

6. A security device for a shipping container of the type having doors with inner and outer sides, a vertically disposed rotatable keeper bar at the outer side of the doors and which is rotatable about a vertical axis and an elongated operating handle having inner and outer sides with one end thereof being pivotally secured, about a horizontally disposed first pivot pin, to the keeper bar with the operating handle being movable between a locked position and an unlocked position with the operating handle being secured in said locked position by a hasp with normally aligned holes for securing the keeper bar, the security device being adapted and arranged for securely locking said container doors when the keeper bar is in said locked position, the security device completely shielding said hasp assembly and completely shielding said operating handle from said hasp assembly to said keeper bar and completely shielding the pivot connection of said operating handle to said keeper bar.
